(19) United States
(12) Patent Application Publication
(10) Pub. No.: US 2019/0319959 A1
(43) Pub. Date: Oct. 17, 2019

(54) Novel Technology for Securing Access to an Enterprise Information System Through a Natural Language Interface

(71) Applicant: Ergonomic Group Inc., Westbury, NY (US)

(72) Inventor: Gene F. Gaffney, Wantagh, NY (US)

(73) Assignee: Ergonomic Group Inc., Westbury, NY (US)

(21) Appl. No.: 15/965,831

(22) Filed: Apr. 27, 2018

Related U.S. Application Data
(60) Provisional application No. 62/657,753, filed on Apr. 14, 2018.

(51) Int. Cl. H04L 29/06; G06F 21/62

(52) U.S. Cl. CPC H04L 63/102; G06F 21/6218; H04L 63/0876; H04L 63/107; H04L 63/0861

(57) ABSTRACT

Technology for securing a user's access to enterprise information through a natural language interface is disclosed. A system for securing access includes computer structures working in concert to identify the user's access permissions based on the initial request, collect further information from the user as required to update or further determine the user's permissions, and to choose a response communication channel appropriate to the user's request. A method for securing access includes receiving a request from a user, determining the user's access permissions, formulating a response based on the user's permissions, choosing the appropriate communication channel for the response, and initiating transmission of the response.

### CROSS-REFERENCE TO RELATED APPLICATIONS

This application claims the benefit of U.S. Provisional Application No. 62/657,753, filed on Apr. 14, 2018, the entirety of which is hereby incorporated by reference.

### BACKGROUND

This invention pertains generally to computer interfaces. More specifically, the technology enables a user to securely access enterprise information systems through a natural language interface.

A natural language interface (“NLI”) allows a user to interact with a computer system (e.g., laptop, server, desktop, smartphone, tablet, smart device) through relatively natural, human, language. This improves the function of the computer system in that the user does not need to know a specialized language to instruct the computer system to perform specific tasks. The user may enter instructions to the computer system through the NLI by, for example, typing or speaking to the computer system. NLIs are the current commercial apex of the evolution of the computer-human interface.

NLIs are computer-resource intense. Because of the NLI's significant need for computer resources, state-of-the-art NLIs typically include a portion that is a cloud-based software service. That is, not every computer system comes with a dedicated NLI. Rather, NLI software generally includes natural-language and voice processors operating on dedicated systems (which may be or may include dedicated segments of a distributed system). A user interacting with a computer system through a NLI typically, therefore, invokes a software service that is run remotely of the computer system being accessed. Thus, the information exchanged between the user and the computer system through the NLI is shared with the remote NLI system. This raises confidentiality and privacy issues.

Enterprise information systems (EISs) include computer systems to collect, store, and manipulate data to further the enterprise's function. For example, such systems may collect and store profit-and-loss, inventory, work-in-progress, order-status, pricing, and human-resource information in real time. Managers may access this information to make better-informed and timely decisions. And employees may access this information to ensure timely and accurate completion of tasks. An enterprise functions more efficiently if members can appropriately and readily access required information. But much of this information is confidential or proprietary to the enterprise. And improper disclosure, use, or modification of the information can harm an enterprise.

NLIs promise to improve the function of enterprise information systems by easing access to enterprise information. Because NLIs simplify a user's interaction with a computer system, NLIs can improve the efficiency with which members access enterprise information. This can, in turn, improve decision making and task completion within the enterprise and thus improve the enterprise over all.

There is a tension, however, between easing access to information and preserving its proprietary or confidential nature. Access to enterprise information should be made available only to appropriate members at the appropriate time. The nature of NLIs, which ease access to information and often involve sharing information outside of the enterprise, must be accounted for when developing technology to allow NLI access to enterprise information.

Accordingly, there is a need for technology that allows the benefits of NLI access to enterprise information while preserving the nature of that information.

### SUMMARY

The present invention is directed to technology for improving access to enterprise information by enabling a request for access through a natural language interface while implementing the request in a manner customized to the nature of the requested access and the identity of the requesting user.

In one aspect of the invention, a method for securing access to enterprise information through a natural language interface includes receiving a user's request (which includes an indication of the user's identity) through a natural language interface, using the indication of the user's identity to determine if the user is permitted the access requested, using the user's access permissions to formulate a response to the request, using the nature of the enterprise information to which the user requested access to choose a communication channel for transmitting the response, and sending the response through the chosen communication channel. In another aspect of the invention, the method for securing access to enterprise information through a natural language interface includes using the user's access permissions to request further information from the user through the natural language interface, receiving that further information, and using the further information to further determine if the user is permitted the requested access. For example, a request may indicate the user is a particular person not in the list or that is without requisite permissions, or it may indicate the user is anonymous. Such a user is not permitted access and the user can be prompted to enter more information to establish permissions. Similarly, if the user is permitted access but only if a certain condition is met (e.g., request entered at a certain time of day, request entered on a certain device), the user can be prompted to enter more information to establish the condition is met.

In another aspect of the invention, a computer system for securing access to enterprise information through a natural language interface includes a means for determining if the user is permitted the access requested by the user based on the user's request, a means for collecting and processing further information from the user to further determine if the user is permitted the requested access, and a means for choosing a communication channel based on the access requested by the user.

In another aspect of the invention, a computer system for securing access to enterprise information through a natural language interface includes a processor configured to: (1) receive a user's request for access to enterprise information wherein the request is received through a natural language interface and includes an indication of the user's identity, (2) compare the user's identity with a list of user permissions to determine if the user is authorized to access the information as requested, and (3) compare the information to which the user requests access with a list of information-communication channels to choose a communication channel for responding to the user's request (e.g., select among existing channels or create a channel based on information in the list). In another aspect of the invention, the processor is configured to: (1) request further information from the user by sending a message to the user through the natural language interface wherein the message includes an indication of a communication channel through which the user will provide the further information, and (2) compare the further information provided by the user with a list of user permissions to determine if the user is authorized to access the information as requested. The configured processor may be, for example, a single processor unit or it may be a distributed processor comprising multiple processor units operating in concert.

### BRIEF DESCRIPTION OF THE DRAWINGS

These and other features, aspects, and advantages of the present invention will become better understood with reference to the following description, appended claims, and accompanying drawings where:

FIG. 1 is a system diagram illustrating an exemplary networked system in which the present invention may operate to secure NLI access to enterprise information.

FIG. 2 is a functional block diagram illustrating an exemplary configuration of an EIS system to secure NLI access to enterprise information.

FIG. 3 is a flow diagram illustrating an exemplary data flow for initial (intake) processing of a user's natural-language instruction to access enterprise information.

FIG. 4 is a flow diagram illustrating an exemplary data flow for determining whether a user is authorized to access enterprise information as requested.

FIG. 5 is a flow diagram illustrating an exemplary data flow for selectively adding permissions or authorization for a user's requested access to enterprise information.

FIG. 6 is a flow diagram illustrating an exemplary data flow for formulating a response to a user's request for access to enterprise information and choosing and invoking an appropriate communication channel to implement the request.

FIG. 7 is a flow diagram illustrating an exemplary data flow for extracting a request from the message received from a NLI server.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

The term “based on,” as used in phrases of the form “[do X] based on [Y]” refers herein to using the information “Y” to perform the function “X” regardless of whether information in addition to “Y” is necessarily or optionally used to perform “X.” That is, “based on” in this context does not mean “based solely on.” Similarly, a function is performed “using” information “Y” regardless of whether information in addition to “Y” is necessarily or optionally used to perform the function. That is, “using” in this context does not mean “using solely.”

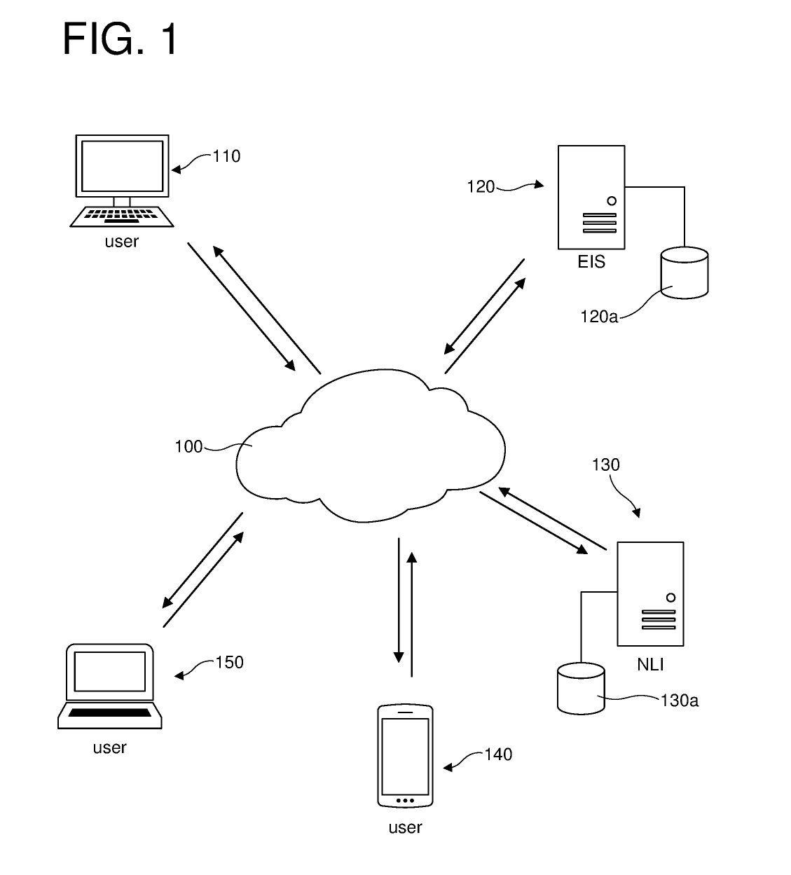

FIG. 1 illustrates an exemplary system for securely accessing an enterprise information system (“EIS”) 120 from a user device 110, 140, 150 via a natural language interface (“NLI”). A user device, such as a personal computer 110, smartphone 140, or laptop 150, receives natural-language information from the user. This information, such as a request for access to enterprise information, may be input, for example, via voice or text entry. The user device 110, 140, 150 sends the natural-language information via a network 100 to a NLI server 130, which includes a NLI data store 130a, for natural-language processing and for voice processing, as appropriate. The network 100 may be, for example, the internet. The NLI server 130 may, as appropriate, respond directly to the user device 110, 140, 150 or send a message to the EIS 120, which includes an EIS data store 120a, for processing of the user input. The EIS 120 identifies the user and determines whether the user is permitted access to the desired enterprise information. If the EIS 120 determines that the user is permitted to access the information, the EIS 120 responds to the user by returning information direct to the user device 110, 140, 150 (through the network 100 but bypassing the NLI server 130) or to the user device through the NLI server 130 (through the network 100). The EIS 120 will route the returned information based on the nature of the information and the identity of the user. (While the components in FIG. 1 are illustrated as unitary devices, it is possible that the components are themselves distributed systems. For example, an EIS typically includes multiple components, each of which may also be a system of components. An EIS may include, for example, an accounting system, a manufacturing system, a customer-relationship system, a supply-chain system, a research-and-development system, a human-resources system, and a data/compute system).

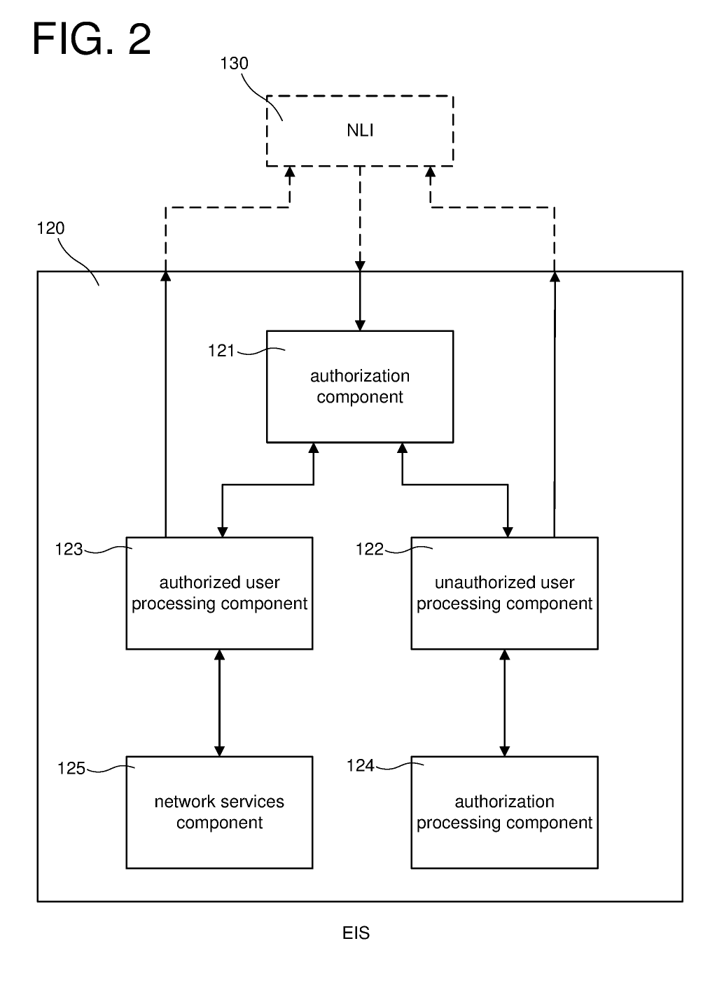

FIG. 2 illustrates an exemplary configuration of the EIS 120. The EIS 120 is includes an authorization component 121, an unauthorized-user-processing component 122, an authorized-user-processing component 123, an authorization-processing component 124, and a network services component 125. The NLI server 130, and associated information flows, is shown in dashed lines for context.

The authorization component 121 is configured to receive and process a message from the NLI server 130. On receipt of the message, the authorization component 121 extracts the user identification from the message, searches for the user in the EIS data store 120a, and determines information-access permissions based on the user identification. The authorization component 121 also extracts the user “request” from the message, compares the request to the user's permissions, and determines if the user may access the information as requested. The “request” may be, for example, a request to read or write enterprise information. Based on the user's identification, permissions, and request, the authorization component 121 invokes the unauthorized-user-processing component 122 or the authorized-user-processing component 123.

The authorization component 121 examines the NLI message to identify key EIS parameters: category, value, and task. EIS categories may include, for example, categories of EIS information such as purchase order, open-order report, user, network switch, and virtual machine. The EIS categories may be associated with one or more values. For example, the purchase order category may be associated with a PO number, a customer, and dates. The open-order report category may be associated with a customer and dates. The user category may be associated with names, contact information, and access permissions. The network switch category may be associated with a switch number. And the virtual machine category may be associated with an identifier, main memory size, and storage size. Similarly, the EIS categories may be associated with tasks, such as get status, create, and send. The actual EIS parameters are appropriately configured for the enterprise.

EIS parameters may be associated with keys in a computer data store. For example, a key table or dictionary can link a word or phrase or form with a particular parameter. “PO” and “purchase order,” for example, may be linked to the PURCHASE ORDER category. A value consisting of three letters followed by eight integers, for example, may be linked to an ORDER-NUMBER value. The keys are appropriately configured for the enterprise.

The authorization component 121 extracts words and phrases from the NLI message and searches for those words/phrases in the key data store to identify the EIS parameters. For example, the authorization component 121 may receive the NLI message in the form of a JSON, XML, or YAML file containing tokens representing the meaning of the words entered by the user (as interpreted by the NLI). The EIS searches the data store for the tokens (which each may be one or more words) to identify key EIS parameters. By identifying the EIS parameters, the EIS extracts the request from the message.

For example, the message “what is the status of purchase order ABC12345678” includes the tokens “status,” “purchase order,” and “ABC12345678” that are found in the key data store and associated with EIS parameters: category—PURCHASE ORDER, value—ABC12345678, and task—GET STATUS. In another example, the message “send me an open order report” includes the tokens “send” and “open order report” associated with EIS parameters: category—OPEN ORDER REPORT and task—SEND. In another example, the message “create a new user John Smith on the accounting system” is associated with EIS parameters: category—USER, name value—JOHN SMITH, system value—ACCOUNTING SYSTEM, and task—CREATE. In another example, “what are the systems connected to Cisco Switch MS1234” is associated with EIS parameters: category—SWITCH, value—MS1234, and task—GET CONNECTED SYSTEMS. In another example, “create a virtual machine with memory 16 Gigabytes and storage 1 Terabyte” is associated with EIS parameters: category—VIRTUAL MACHINE, memory value—16 GB, storage value—1 TB, and task—CREATE.

The unauthorized-user-processing component 122 is configured to process situations in which the user is not identifiable in the EIS data store 120a or in which the user is not permitted access to the requested information. If the user identification extracted from the message from the NLI server 130 is not associated with a valid user in the EIS data store 120a, the unauthorized-user-processing component 122 prompts the user for further identifying information (e.g., an email address and password, fingerprint, retinal scan). For example, the unauthorized-user-processing component 122 can send a message to the user device 110, 140, 150 through the NLI server 130 to prompt the user to enter specific identifying information through the NLI. Or the unauthorized-user-processing component 122 can invoke the authorization processing component 124 to create a communication link (e.g., URL, text message, email message) to accept the user's input of the specific identifying information. The unauthorized-user-processing component 122 can send a message to the user device 110, 140, 150 through the NLI server 130 to prompt the user to enter information via the link (e.g., visit the URL and type in the information, send a text message with the information, send an email to the EIS). In another example, the unauthorized-user-processing component 122 can send a message to the user through another communication channel, such as a text message or email, to prompt the user to enter information via the link (e.g., visit the URL and type in the information, respond to a text message from the EIS, respond to an email sent from the EIS).

The unauthorized-user-processing component 122 analyzes the further identifying information provided by the user to determine if the user may access the requested information. If the user is permitted access, the EIS 120 will provide the requested information. If not, the request will be rejected and the user may be notified through the NLI. For example, if the user provides an approved email address (e.g., based on the entire address or just the domain), the unauthorized-user-processing component 122 will invoke the authorization component 121 to authorize access and process the request. Optionally, the ESI data store 120a may be updated to associate the identification provided in the message from the NLI server 130 with the access permissions associated with the further identifying data such that subsequent similar requests will be approved by the authorization component 121.

The authorized-user-processing component 123 is configured to process situations in which the user is identified in the EIS data store 120a as having the requisite permission to access the requested information. If the user identification extracted from the message from the NLI server 130 is associated with a valid user in the EIS data store 120a and the user is permitted the requested access, the authorized-user-processing component 123 will formulate the appropriate response to the request and appropriately route the response to the user. For example, if the user requested the status of a specific purchase order, the authorized-user-processing component 123 may formulate a message with, for example, “NEW on <DATE>,” “RELEASED on <DATE>,” “RECEIVED on <DATE>,” “CANCELED on <DATE>,” or “CLOSED on <DATE>.” In another example, if the user requested sales and gross margin information segmented by customers and geography, the authorized-user-processing component 123 may formulate a message with a comprehensive report. The response will be routed to the user device 110, 140, 150 based on the nature of the information. For example, a simple response for which there is little confidentiality concern may be routed through the NLI server 130. A complicated response for which there is a confidentiality concern may be sent to the user's email address. Or the authorized-user-processing component 123 may respond by providing a secure link (e.g., URL) to the requested information.

The authorized-user-processing component 123 may invoke a network services component 125 in order to access enterprise information. For example, a user may request, via a user device 110, 140, 150 and the NLI 130, the creation or use of a virtual machine in the enterprise's data center. In such a situation, the authorized-user-processing component 123 will formulate a message to the network services component 125 which initiates the creation or use of the virtual machine. In another example, a user may request to add or delete a user or to change a user's permission in the ESI data store 120a. The authorized-user-processing component 123 would then invoke the network services component 125 to update the ESI data store 120a.

The authorized-user-processing component 123 uses the request extracted by the authorization component 121 to determine the format and route of the response to the request. The format and route are associated with the EIS parameters identified by the authorization component 121. For example, the EIS parameter set [category—PURCHASE ORDER, value—ABC12345678, task—GET STATUS] is associated with instructions to collect the status information from the appropriate EIS component (e.g., a networked enterprise resource planning system or API) and to send the status information to the user via the NLI: “purchase order ABC12345678 was received and entered as order 13554500 and is being picked.” In another example, the EIS parameter set [category—OPEN ORDER REPORT, task—SEND] is associated with instructions to collect the open-order information, assemble the report, and send it to the email address associated with the user. In another example, the EIS parameter set [category—USER, name value—JOHN SMITH, system value—ACCOUNTING SYSTEM, task—CREATE] is associated with instructions to to create a new user with the name John Smith on the accounting system and to send a confirmation to the user via the NLI: “John Smith was created on the accounting system.” In another example, the EIS parameter set [category—SWITCH, value—MS1234, task—GET CONNECTED SYSTEMS] is associated with instructions to collect the information, post the information to a secure website, and send the URL of the website via text message to the number associated with the user. In another example, the EIS parameter set [category—VIRTUAL MACHINE, memory value—16 GB, storage value—1 TB, task—CREATE] is associated with instructions to create the virtual machine in EIS data center, create a password-protected Web interface to the virtual machine, send the interface's URL to the email address associated with the user, and send the password to the text-message number associated with the user.

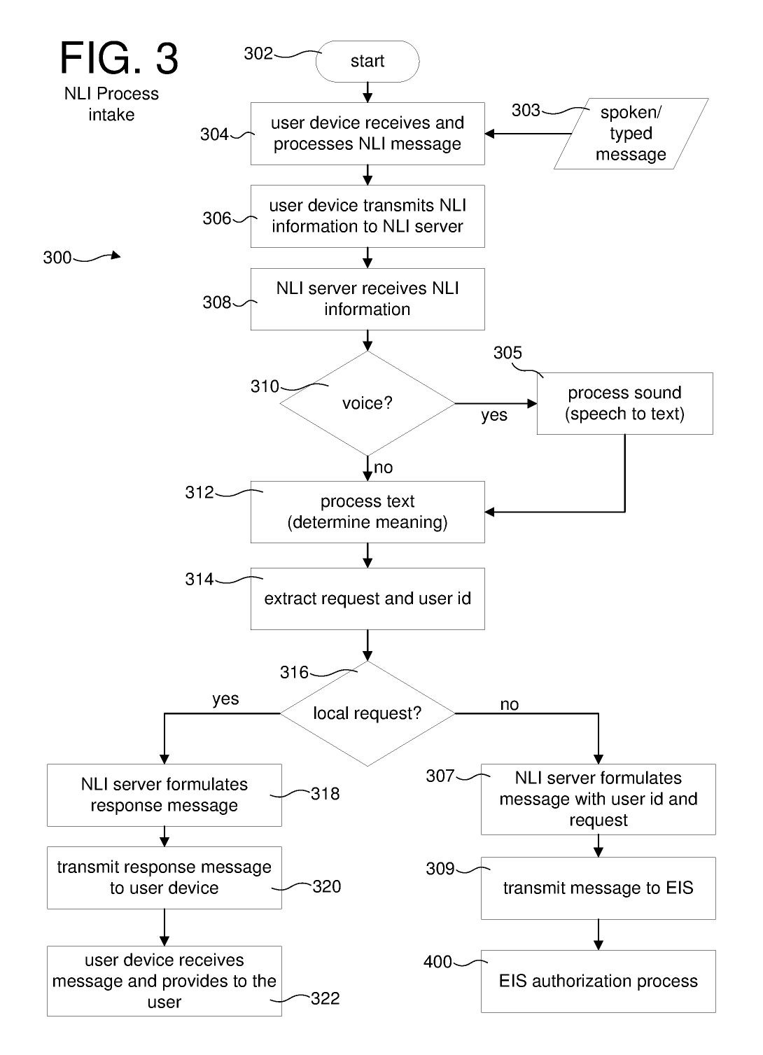

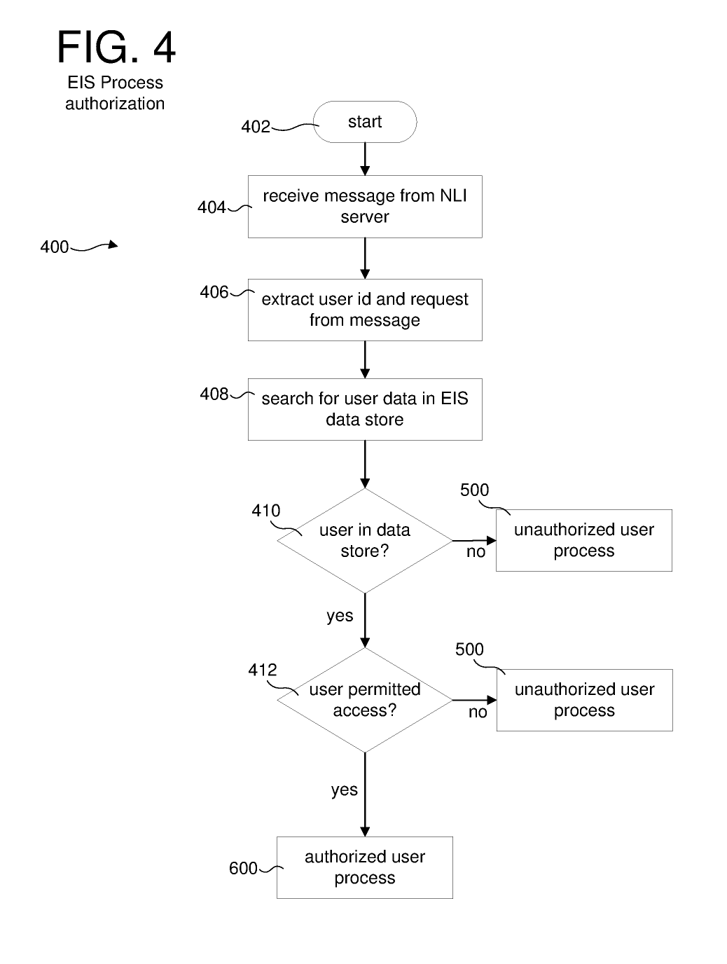

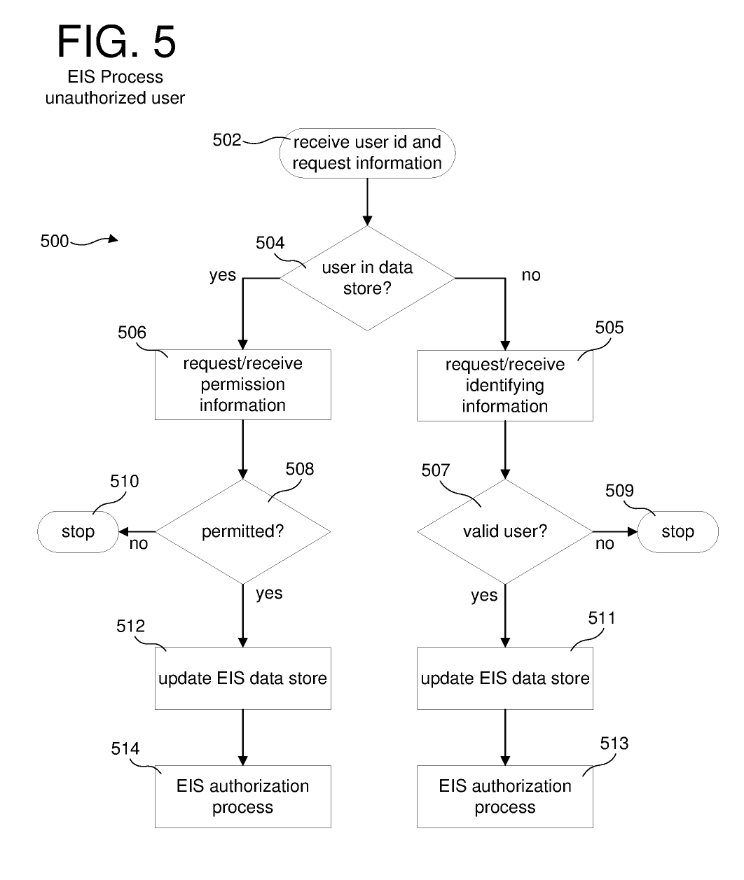

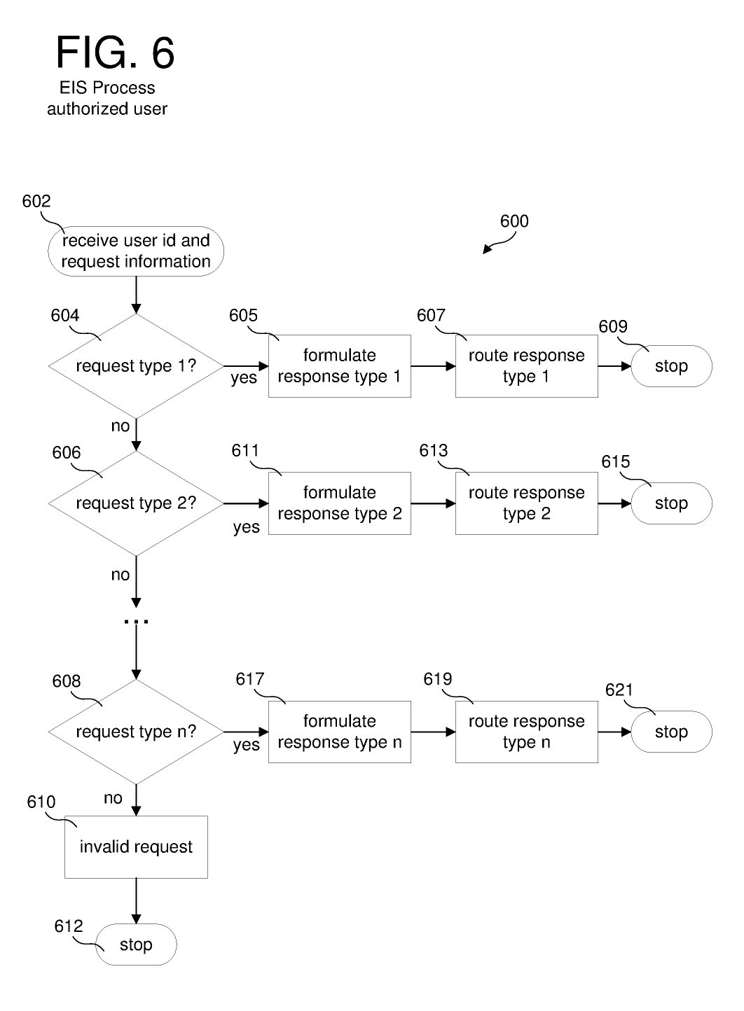

The technology to secure access to an enterprise information system via a natural language interface may be better understood with reference to the exemplary data flows illustrated in FIGS. 3-6. FIG. 3 illustrates an exemplary data flow for initial processing of the user's natural-language request. FIG. 4 illustrates an exemplary data flow for determining whether the user is authorized for the requested access to enterprise information. FIG. 5 illustrates an exemplary data flow for processing a request from an unauthorized user. FIG. 6 illustrates an exemplary data flow for processing a request from an authorized user.

In the exemplary data flow illustrated in FIG. 3, a user device starts 302 and listens for input from the user. The user inputs a natural-language request 303 and the device receives and processes the request 304. For example, the user may speak or type into the device and the device will receive the spoken/typed input and then structure the input for transmission to a NLI server. When the user's input is appropriately structured by the device, the device transmits the information to a NLI server 306. The NLI server receives the information 308 and processes the information. Processing at the NLI server includes determining if the input is spoken 310, in which case the NLI server will convert the spoken input into text 305. The NLI processing further includes determining the meaning (at least in part) of the user's input by processing the text representation of that input 312. The NLI process extracts a user identification from the request data (including metadata) provided by the user device 314. For example, the user may be identified through an identifying address of the user device, by recognition of the user's voice, or by body-feature recognition such as facial or finger-print recognition. The NLI server will examine the request to determine if it is a request that the NLI server can handle locally 316. If the request is one that can be handled locally, the NLI server will formulate a response 318, transmit the response to the user device 320, and the user device will provide the response to the user 322. If the request is one that is directed to an EIS, the NLI server will formulate a message to the EIS 307. The message to the EIS will include a user identification (“USER ID”) and a representation of the access requested (“REQUEST”). The message is transmitted to the EIS 309 and the EIS begins the authorization process 400.

An exemplary data flow for the EIS authorization process 400 is illustrated in FIG. 4. The EIS receives the message from the NLI server 404 and extracts the USER ID and REQUEST from the message 405. Based on the USER ID, the EIS searches for user data in the EIS data store 408. The EIS determines whether there is user data associated with the USER ID 410. If not, the EIS begins the unauthorized user process 500. If there is user data associated with the USER ID, the EIS determines if the user is permitted access to the requested information 412. If not, the EIS begins the unauthorized user process 500. If the user is permitted the requested access, the EIS begins the authorized user process 600.

An exemplary data flow for the EIS unauthorized user process 500 is illustrated in FIG. 5. The unauthorized user process 500 receives information concerning the USER ID and REQUEST and an indication of why the user is not authorized 502. Based on the information it receives, the unauthorized user process 500 determines whether to request user-identifying information or user-permission information 504.

If the USER ID is not in the data store, the process 500 will request user-identifying information from the user 505. The request may be implemented, for example, by formulating and sending a message to the NLI server to request the user enter the information through the user device and NLI server. In another example, the request may be implemented by formulating and sending a message to the NLI server to request the user enter the information through a URL or other link provided by the EIS. In another example, the request may be implemented by formulating and sending a message to the user through a different communication channel, such as a text message or email. The unauthorized user process 500 receives the requested identifying information as entered by the user 505. The process 500 checks the received user-identifying information against an approved list to determine if the user is a valid user 507. For example, if the requested information includes an email address and password associated with the email address, the check 507 will include comparing the email-address/password set against approved email-address/password sets. If the check determines that the user is not valid, the process will stop 509 and the request is denied and the user may be notified through the NLI. If the check determines that the user is valid, the EIS data store is updated to associate the user id with the user information associated with the user-identifying information 511. The process 500 then proceeds to invoke the authorization process to continue processing the request 513.

If the USER ID is in the data store, the process 500 will request user-permission information from the user 506. The request may be implemented by, for example, formulating and sending a message to the NLI server to request the user enter the information through the user device and NLI server. In another example, the request may be implemented by formulating and sending a message to the NLI server to request the user enter the information through a URL or other link provided by the EIS. In another example, the request may be implemented by formulating and sending a message the user through a different communication channel, such as a text message or email. The unauthorized user process 500 receives the requested identifying information as entered by the user 506. The process 500 checks the received user-permission information against an approved list to determine if the user is permitted to access the information 508. For example, if the requested information includes an email address and password associated with the email address, the check 508 will include comparing the email-address/password set against email-address/password sets approved for the requested access. If the check determines that the user is not authorized for the requested access, the process will stop 510 and the request is denied and the user may be notified through the NLI. If the check determines that the user is permitted the access, the EIS data store is updated to associate the user id with the user information associated with the user-identifying information 512. The process 500 then proceeds to invoke the authorization process to continue processing the request 514.

In the exemplary flow depicted in FIG. 5, the process 500 automatically invokes the authorization process to continue processing the event. In another example, the process 500 may instead stop after updating the EIS data store and then wait for the user to reenter the request, or to enter a new request.

An exemplary data flow for the EIS authorized user process 600 is illustrated in FIG. 6. The process 600 receives the USER ID (or some other user-identifying information) and the REQUEST (or some representation of the REQUEST). The process 600 checks the REQUEST against a list of known requests 604, 606, 608. If the REQUEST is not a known request type, the request is deemed invalid 610, the process stops 612, the request is denied, and the user may be notified through the NLI. The ellipsis in the flow chart indicates potentially multiple checks between the check for a “type 2” request 606 and the check for the “type n” request 608. In principle, there may be anywhere between one acceptable type of request and thousands (or more) of acceptable types of request, each associated with one or more REQUESTS. If the REQUEST is identified as an acceptable request, the process 600 formulates the appropriate response 605, 611, 617 and routes the response back to the user 607, 613, 619. Once the process 600 sends the appropriately formulated response to the user via the appropriate route, the process 600 stops and the request has been satisfied.

That is, each request type is associated with both a response formulation and a response route comprising a communication channel. By identifying the type of request to which the REQUEST belongs, the process 600 identifies and invokes the proper response formulation and transmission route. For example, a REQUEST for the status of a purchase order may involve the EIS system determining that status, wrapping that status in a message, and routing the message back to the user through the NLI server. In another example, a REQUEST for the enterprise's most recent profit-and-loss data may involve the EIS system collecting that information, assembling the information in a report, placing the report at a secure site, wrapping a link to the secure site in a message, and routing the message back to the user device through the NLI server. In another example, a REQUEST to restrict a specific user's access to the EIS (if the user's employment was terminated, for example) may involve the EIS system formulating and implementing a message to update the EIS to remove or restrict that user's access. The response to the requesting user may then be a simple message through the NLI server confirming the task is accomplished.

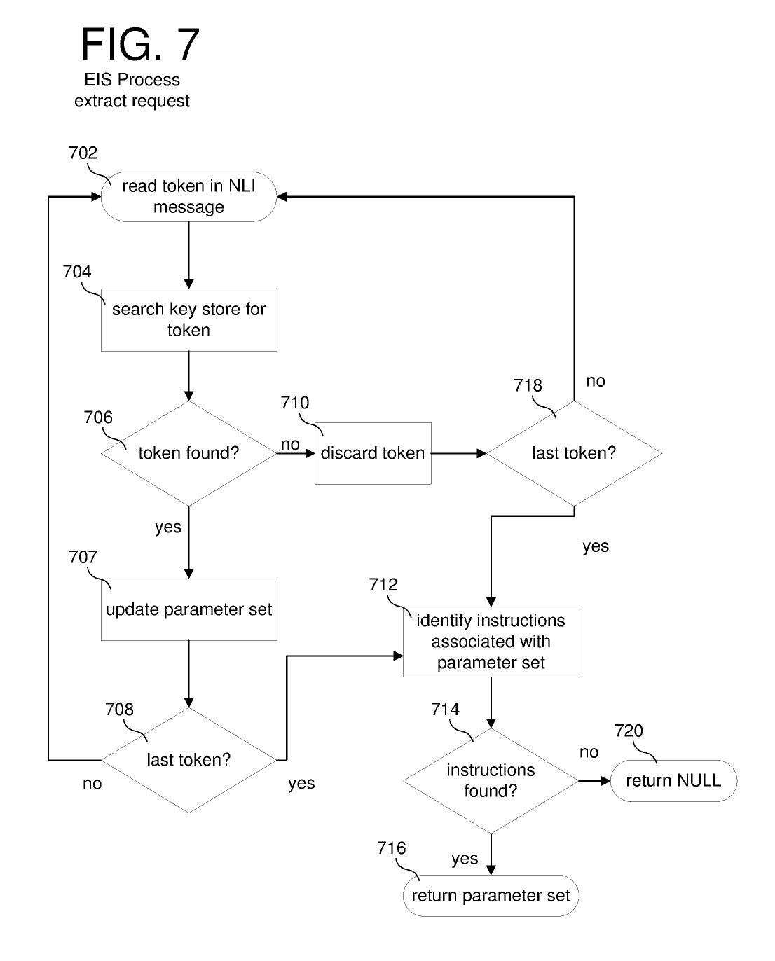

An exemplary data flow for the EIS's process to extract the request from the message received from the NLI server is illustrated in FIG. 7. The message includes tokens representing the meaning of the words entered by the user (as interpreted by the NLI). The flow starts by reading a token from the NLI message 702. Then the process searches a store of EIS parameter data to determine if the token is associated with a parameter 704. For example, the token may be associated with a category of EIS information (e.g., purchase orders), a value (e.g., PO number), or a task (e.g., status). If the token is associated with a parameter, the parameter is added to a set of parameters associated with the message 707. If the token is not associated with a parameter, the token is discarded 710. After the search for the token is complete and either the parameter set was updated 707 or the token discarded 710, the system checks to see if there are more NLI-message tokens to process 708, 718. If there are more tokens, the process returns to read the next token 702. If there are no more tokens, the process searches a store of parameter data to determine if there are instructions associated with the parameter set 712. If there are instructions, the process returns the parameter set 716. If there are no instructions, the process returns a NULL or some other indicator that the request is not understood 720. In one alternate flow, the process may return the parameter set without first searching for associated instructions. In another alternate flow, if there are no associated instructions, the process may retokenize the NLI message and try again to extract the request, this time reading from a modified (retokenized) NLI message.

As described above, the invention allows natural-language access to enterprise information, including through a remote third-party natural language interface server, while preserving the confidential and proprietary nature of the enterprise information. Because the invention eases access while preserving the nature of the information, the invention improves the function of the enterprise information system and ultimately improves the operations of the enterprise.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A method for securing natural language access to enterprise information, the method comprising:
(a) receiving a request for access to enterprise information from a user through a natural language interface, wherein the request for access is entered by the user through a user device and includes an indication of the user's identity;
(b) determining, based on the indication of the user's identity, whether the user is authorized for the requested access;
(c) formulating a response to the request for access to enterprise information based on whether the user is authorized for the requested access;
(d) choosing, based on the enterprise information to which the user requested access, a communication channel for responding to the request for access to enterprise information; and
(e) initiating sending of the response.

2. The method of claim 1 further comprising:
(a) requesting further information from the user if the determining step determines that the user is not authorized for the requested access, wherein the requesting further information is through the natural language interface;
(b) receiving the further information from the user; and
(c) further determining, based on the further information, whether the user is authorized for the requested access.

3. The method of claim 2 wherein receiving the further information is through the natural language interface.

4. The method of claim 2 further comprising providing a link to the user through the natural language interface and wherein receiving the further information is through the link.

5. The method of claim 2 wherein the further information is one of the group consisting of a scan of the user's fingerprint, a scan of the user's face, and a scan the user's retina.

6. The method of claim 1 wherein the request for access includes an indication of the user's geographic location, the method further comprising determining, based on the indication of the user's location, whether the user is authorized for the requested access.

7. The method of claim 1 further comprising determining, based on the time of the request is received, whether the user is authorized for the requested access.

8. The method of claim 1 wherein the request for access includes an indication of the identity of the device through which the user entered the request, the method further comprising determining, based on the indication of the identity of the device, whether the user is authorized for the requested access.

9. The method of claim 1 wherein the request for access includes an indication of the IP address of the device through which the user entered the request, the method further comprising determining, based on the indication of the IP of the device, whether the user is authorized for the requested access.

10. The method of claim 1 further comprising:
(a) requesting further information from the user if the determining step determines that the user is conditionally authorized for the requested access, wherein the requesting further information is through the natural language interface;
(b) receiving the further information from the user; and
(c) further determining, based on the further information, whether a condition for user access is satisfied.

11. The method of claim 10 wherein the further information is one of the group consisting of a scan of the user's fingerprint, a scan of the user's face, a scan of the user's retina, a recording of the user's voice, a solution to a CAPTCHA challenge, and a biometric entry of a code.

12. The method of claim 10 wherein the further information is one of the group consisting of the user's device's MAC address, and the user's device's IP address, the user's device's UDID, the user's device's IMEI, the user's device IMSI, the user's device's MEID, the user's device's ICID, the user's device's ESN, the user's device's serial number, the user's device's ANDROID ID, the user's device's UUID, and the user's device's GPS coordinates.

13. The method of claim 10 wherein receiving the further information is through the natural language interface.

14. The method of claim 10 further comprising providing a link to the user through the natural language interface and wherein receiving the further information is through the link.

15. The method of claim 1 further comprising:
(a) choosing a further-information communication channel based on the request for access;
(b) requesting further information from the user through the further-information communication channel;
(c) receiving the further information from the user;
(d) further determining, based on the further information, whether a condition for user access is satisfied.

16. A computer system for securely processing a user's natural-language request for access to enterprise information, the computer system comprising:
(a) a means for determining, based on a user's natural-language request for access to enterprise information, whether the user is authorized for access to enterprise information requested by the user;
(b) a means for collecting and processing further information from the user, wherein the collecting and processing the further information is to further determine whether the user is authorized for the requested access to enterprise information; and
(c) a means for choosing a communication channel based on the requested access.

17. A computer system for securing natural language access to enterprise information, the system comprising a processor configured to:
(a) receive a request for access to enterprise information from a user through a natural language interface wherein the request includes user-identifying information;
(b) determine whether the user is authorized for the requested access to enterprise information by comparing the user-identifying information with a list of authorized users, wherein the list includes entries defining, for each authorized user on the list, a permitted access to enterprise information for the authorized user; and
(c) choose a communications channel based on the enterprise information to which the user requests access by comparing the enterprise information to which the user requests access to a list of enterprise information, wherein the list includes entries defining a communication channel for each item of enterprise information on the list.

18. The computer system of claim 17 wherein the processor is further configured to:
(a) prompt the user to provide further information by sending a request for further information to the user through the natural language interface, wherein the request for further information includes an identification of a communication channel by which the user is to provide the further information; and
(b) further determine whether the user is authorized for the requested access to enterprise information by comparing the further information provided by the user with a list of authorized users, wherein the list includes entries defining, for each authorized user on the list, a permitted access to enterprise information for the authorized user.

19. The computer system of claim 17 wherein the processor is further configured to:
(a) choose a communication channel based on the user's request for access;
(b) prompt the user to provide further information by sending a request for further information to the user through the communication channel, wherein the request for further information includes an identification of a communication channel by which the user is to provide the further information; and
(c) further determine whether the user is authorized for the requested access to enterprise information by comparing the further information provided by the user with a list of authorized users, wherein the list includes entries defining, for each authorized user on the list, a permitted access to enterprise information for the authorized user.

20. The computer system of claim 17 wherein the processor is a distributed processor comprising multiple processor units.
